(19) United States
(12) Patent Application Publication
(10) Pub. No.: US 2017/0205357 A1
(43) Pub. Date: Jul. 20, 2017

(54) Tamper-Indicating Device

(71) Applicant: President and Fellows of Harvard College, Cambridge, MA (US)

(72) Inventors: Ian BURGESS, Toronto (CA); Cicely SHILLINGFORD, Waterloo (CA); Joanna AIZENBERG, Boston, MA (US)

(21) Appl. No.: 15/320,650

(22) PCT Filed: Jun. 22, 2015
(86) PCT No.: PCT/US15/36977

§ 371 Date: Dec. 20, 2016

Related U.S. Application Data
(60) Provisional application No. 62/015,606, filed on Jun. 23, 2014.

(51) Int. Cl. G01N 21/78; G01N 31/22

(52) U.S. Cl. CPC G01N 21/783; G01N 31/225

(57) ABSTRACT

A tamper-indicating device comprising is described, including a gas-permeable casing; and a first gas-sensitive compound encapsulated within the gas-permeable casing, wherein the first gas-sensitive compound is selected to provide a visual response upon exposure to gas.

### RELATED APPLICATIONS

This application claims the priority and benefits to U.S. Provisional Application No. 62/015,606, filed Jun. 23, 2014, the entire content of which is expressly incorporated by reference.

### FIELD OF THE INVENTION

The present disclosure generally relates to the field of tamper-indicating devices.

### BACKGROUND

There is an increasing demand across many industries for materials whose chemical and physical properties change when exposed to specific environmental stimuli. These materials are finding use in sensors, controlled-release devices, self-healing technology, photo-responsive materials, and homeostatic materials, to name a few applications. For many of these applications, the response is reversible and reproducible against many response cycles. As a result, there has been a large body of recent research engineering materials with reversible responses to a large number of stimuli.

There are, however, a few applications where irreversible responses are preferred. One such example is that of tamper-indicating materials, whose incorporation into consumer products (e.g., food, liquor, pharmaceuticals) or military and security devices has become an increasingly popular strategy to counteract the widespread threats of forgery and tampering. Tamper-indicating materials are distinct from other types of security features in that they are designed to irreversibly make a record of some prior tampering event and easily report that information to someone who comes to check on it later. Despite their widespread use, most current tamper-indicating technologies are highly susceptible to attack. For example, a recent large-scale study of 213 different tamper-indicating seals, including some that are used as nuclear safeguards, found that most can be defeated in 5 minutes or less by one person using low-tech methods. Developing the next generation of tamper-indicating materials will require the optimization of stimuli-responsive materials for irreversible response as well as engineering efforts to tailor the response to stimuli that are likely to uniquely occur during a tampering event.

An indicator of compromised integrity for many consumer or military products or devices is prior opening of a sealed container (e.g., opening the packaging, uncapping a bottle, tampering with the device components, etc.). Materials designed to indicate product opening can do so through response to either mechanical forces associated with the act of opening a container or to exposure to elements of the outside environment (e.g., light, oxygen, humidity). Materials that are acutely sensitive to oxygen or humidity have promise for very high tamper-sensitivity, but their high reactivity in ambient conditions is frequently accompanied by high toxicity, limiting the practicality in consumer applications (e.g., food, liquor, pharmaceuticals).

Toxicity is also a challenge faced when developing stimuli-responsive materials for medical applications. Partly due to this challenge, many materials have been developed for these applications using a biologically inspired approach, focusing on actuation mechanisms that mimic the wide range of responsive systems in our bodies, which can perform sophisticated functions without collateral damage.

Additionally, the temper-indicating device may be used to detecting tempering with sensitive military package (e.g., explosives or weapon system) and classified documents.

Thus, there remains a need for tamper-indicating devices which are simple, safe, sensitive, and compatible with consumer or security product.

### SUMMARY

Described herein is a tamper-indicating device which is used to indicate and detect prior tampering, e.g., opening, of a sealed package and/or exposure of the interior of the package to a gas, e.g., a particular gas as described herein. The package may contain a consumer product, e.g., wine, drug, or highly sensitive product, e.g., weapon, classified document, biosample, that is packed with the tamper-indicating device sealed therein. The use of any commercial product known in the art is contemplated. Non-limiting examples of the particular gases include oxygen, CO, CO₂, phosgene, water vapor, HCl, H₂S, SO₂, NO₂, NH₃, O₃, NO, volatile explosives, nerve gases (e.g., phosgene) toxic gas, and a combination thereof. It may also include detection of explosives, life-threatening, dangerous compounds, such as phosgene, mustard gases (sulphur mustard agents), sarin, tabun, cyclosarin, soman, V-series nerve agents (e.g., VX), and explosives which is gas or may generate a detectable gas. Non limiting examples of explosives include pentaerythritol tetranitrate, nitroglycerin, peroxyacetone, 1,3,5-Trinitroperhydro-1,3,5-triazine, and trinitrotoluene. The detection of any gas known in the art is contemplated. In certain embodiments, the gas is oxygen. In these embodiments, the atmosphere inside the package containing the tamper-indicating can be substantially free of the particular gas of interest such as oxygen, e.g., less than 10%, 5%, 1%, or 0.1% of the gas (e.g., oxygen) or having the gas (e.g., oxygen) in any range of percentages bounded by any two values of the percentages disclosed herein. In the case of oxygen-sensitive detection, the tamper-indicating device contains a first oxygen-sensitive compound which, upon exposure to oxygen, provides a visual indicator of exposure, for example, an indicator compound with a color different from the first oxygen-sensitive compound is formed. This process can be irreversible so that if the package is examined later and the color of the indicator compound is observed, a user can determine that the package has been tampered with previously. In some embodiments, the package that contains the tamper-indicating device is made of a material that is impermeable to gas, e.g., a material having gas permeability coefficients of less than 0.1, 0.09, 0.08, 0.07, 0.06, 0.05, 0.04, 0.03, 0.02, or 0.01; or having gas permeability coefficients in any range bounded by any two values disclosed herein. In some specific embodiments, at least part of the package and/or casing is transparent to allow a user to directly observe the inside of the package to observe the color of the first gas-sensitive compound or the indicator compound in the tamper-indicating device, without having to open the package. This is particularly advantageous in the case of oxygen, as a user, e.g., a consumer or buyer, can determine whether the package has been tampered before purchasing the product in the package.

In one aspect, a tamper-indicating device is described, including a gas-permeable casing; and a first gas-sensitive compound encapsulated within the gas-permeable casing, wherein the first gas-sensitive compound is selected to provide a visual response upon exposure to a gas.

In any of the proceeding embodiments, the visual indication is color change.

In any of the proceeding embodiments, the gas is selected from the group consisting of oxygen, CO, CO₂, water vapor, HCl, H₂S, SO₂, NO₂, NH₃, O₃, NO, volatile explosives, a toxic gas, nerve gases (e.g., phosgene), and a combination thereof.

In any of the proceeding embodiments, the intensity of the visual response is an indicator of the extent of gas exposure.

In any of the proceeding embodiments, the casing comprises one or more openings or pores to allow the gas to permeate into the casing.

In any of the proceeding embodiments, at least a portion of the casing is transparent to allow viewing of the visual response.

In any of the proceeding embodiments, the first gas-sensitive compound is colorless and the visual response comprises a color change to a yellow, brown, or black color.

In any of the proceeding embodiments, the casing is hydrophobic.

In any of the proceeding embodiments, the casing is water-impermeable.

In any of the proceeding embodiments, the casing is made of rubber.

In any of the proceeding embodiments, the casing is hydrophilic.

In any of the proceeding embodiments, the casing is oil-impermeable.

In any of the proceeding embodiments, the casing is made of silicone.

In any of the proceeding embodiments, the first gas-sensitive compound is encapsulated at a depth about 0.1-10 mm below the surface of the casing.

In any of the proceeding embodiments, the gas is oxygen and the first gas-sensitive compound is a first oxygen-sensitive compound.

In any of the proceeding embodiments, the oxygen-sensitive compound is a synthetic precursor of melanin.

In any of the proceeding embodiments, the synthetic precursor of melanin forms melanin upon oxygen exposure.

In any of the proceeding embodiments, the first oxygen-sensitive compound is an artificial melanosome.

In any of the proceeding embodiments, the first oxygen-sensitive compound has the structure of formula (I), a salt, or a hydrate thereof,

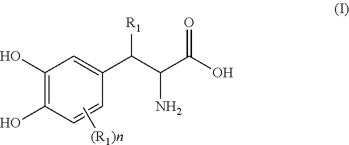

wherein n is 0, 1, 2, or 3; each occurrence of R₁ is independently selected from the group consisting of H, halogen, alkyl, alkenyl, cycloalkyl, alkylcycloalkyl, OH, SH, ORₐ, O(C═O)Rₐ, (C═O)ORₐ, (C═O)Rₐ, NH₂, NO₂, NRₐR_{b}, NRₐ(C═O)R_{b}, (C═O)NRₐR_{b}, NRₐ(C═O)OR_{b}, and O(C═O)NRₐR_{b}, wherein each occurrence of Rₐ and R_{b} is independently selected from the group consisting of H, halogen, alkyl, and cycloalkyl, or alternatively Rₐ and R_{b}, when connected to N, taken together with the nitrogen atom to which they are connected form a heterocycle comprising 1-4 heteroatoms, which may be optionally substituted by from one to four groups which may be the same or different (C₁-C₄)alkyl.

In any of the proceeding embodiments, wherein R₁ is H.

In any of the proceeding embodiments, the first gas-sensitive compound is selected to provide the visual response after a predetermined time period after its exposure to the gas.

In any of the proceeding embodiments, the predetermined time period is from about 1 min to about 5 h.

In any of the proceeding embodiments, the tamper-indicating device further includes one or more gas-sensitive compound encapsulated within the gas-permeable casing and each selected to provide visual response upon exposure to a gas.

In any of the proceeding embodiments, the one or more gas-sensitive compound and the first gas-sensitive compound are encapsulated at the same or different depth below the surface of the casing.

In any of the proceeding embodiments, the one or more gas-sensitive compound and the first gas-sensitive compound are selected to provide visual responses upon exposure to the same or different gas.

In another aspect, a method of detecting tampering of a product contained in a package substantially free of a gas and containing the tamper-indicating device of any one of the embodiments described herein is described, including examining the device for the visual response to determine if the product has been exposed to the gas.

In any of the proceeding embodiments, the gas is oxygen and the first gas-sensitive compound is a first oxygen sensitive compound.

In any of the proceeding embodiments, the atmosphere inside the package contains less than 10%, 5%, or 1% oxygen.

In any of the proceeding embodiments, upon exposure to oxygen, the first oxygen sensitive compound forms an indicator compound with a color different from the first oxygen-sensitive compound and an appearance of the color of the indicator compound upon subsequent examination of the tamper-indicating device indicates prior tampering of the package.

In any of the proceeding embodiments, the package is at least partially transparent to allow a user to examine the color of the first oxygen-sensitive compound or the visual response.

Unless otherwise defined, used or characterized herein, terms that are used herein (including technical and scientific terms) are to be interpreted as having a meaning that is consistent with their accepted meaning in the context of the relevant art and are not to be interpreted in an idealized or overly formal sense unless expressly so defined herein. For example, if a particular composition is referenced, the composition may be substantially, though not perfectly pure, as practical and imperfect realities may apply; e.g., the potential presence of at least trace impurities (e.g., at less than 1 or 2%) can be understood as being within the scope of the description; likewise, if a particular shape is referenced, the shape is intended to include imperfect variations from ideal shapes, e.g., due to manufacturing tolerances. Percentages or concentrations expressed herein can represent either by weight or by volume.

Although the terms, first, second, third, etc., may be used herein to describe various elements, these elements are not to be limited by these terms. These terms are simply used to distinguish one element from another. Thus, a first element, discussed below, could be termed a second element without departing from the teachings of the exemplary embodiments. Spatially relative terms, such as “above,” “below,” “left,” “right,” “in front,” “behind,” and the like, may be used herein for ease of description to describe the relationship of one element to another element, as illustrated in the figures. It will be understood that the spatially relative terms, as well as the illustrated configurations, are intended to encompass different orientations of the apparatus in use or operation in addition to the orientations described herein and depicted in the figures. For example, if the apparatus in the figures is turned over, elements described as “below” or “beneath” other elements or features would then be oriented “above” the other elements or features. Thus, the exemplary term, “above,” may encompass both an orientation of above and below. The apparatus may be otherwise oriented (e.g., rotated 90 degrees or at other orientations) and the spatially relative descriptors used herein interpreted accordingly. Further still, in this disclosure, when an element is referred to as being “on,” “connected to,” “coupled to,” “in contact with,” etc., another element, it may be directly on, connected to, coupled to, or in contact with the other element or intervening elements may be present unless otherwise specified. In some embodiments, the term “oxygen-sensitive compound” and “first oxygen-sensitive compound” may be used interchangeably.

The terminology used herein is for the purpose of describing particular embodiments and is not intended to be limiting of exemplary embodiments. As used herein, singular forms, such as “a” and “an,” are intended to include the plural forms as well, unless the context indicates otherwise. Additionally, the terms, “includes,” “including,” “comprises” and “comprising,” specify the presence of the stated elements or steps but do not preclude the presence or addition of one or more other elements or steps.

The terms “alkyl” and “alk” refer to a straight or branched chain alkane (hydrocarbon) radical containing from 1 to 12 carbon atoms, preferably 1 to 6 carbon atoms. Exemplary “alkyl” groups include methyl, ethyl, propyl, isopropyl, n-butyl, t-butyl, isobutyl pentyl, hexyl, isohexyl, heptyl, 4,4-dimethylpentyl, octyl, 2,2,4-trimethylpentyl, nonyl, decyl, undecyl, dodecyl, and the like. The term “(C₁-C₄)alkyl” refers to a straight or branched chain alkane (hydrocarbon) radical containing from 1 to 4 carbon atoms, such as methyl, ethyl, propyl, isopropyl, n-butyl, t-butyl, and isobutyl. “Substituted alkyl” refers to an alkyl group substituted with one or more substituents, preferably 1 to 4 substituents, at any available point of attachment. Exemplary substituents include but are not limited to one or more of the following groups: hydrogen, halogen (e.g., a single halogen substituent or multiple halo substitutents forming, in the latter case, groups such as CF₃ or an alkyl group bearing CCl₃), cyano, nitro, oxo (i.e., ═O), CF₃, OCF₃, cycloalkyl, alkenyl, cycloalkenyl, alkynyl, heterocycle, aryl, ORₐ, SRₐ, S(═O)Rₑ, S(═O)₂Rₑ, P(═O)₂Rₑ, S(═O)₂ORₑ, P(═O)₂ORₑ, NR_{b}R_{c}, NR_{b}S(═O)₂Rₑ, NR_{b}P(═O)₂Rₑ, S(═O)₂NR_{b}Rₑ, P(═O)₂NR_{b}Rₑ, C(═O)OR_{d}, C(═O)Rₐ, C(═O)NR_{b}Rₑ, OC(═O)Rₐ, OC(═O)NR_{b}R_{c}, NR_{b}C(═O)ORₑ, NR_{d}C(═O)NR_{b}R_{c}, NR_{d}S(═O)₂NR_{b}R_{c}, NR_{d}P(═O)₂NR_{b}R_{c}, NR_{b}C(═O)Rₐ, or NR_{b}P(═O)₂Rₑ, wherein each occurrence of Rₐ is independently hydrogen, alkyl, cycloalkyl, alkenyl, cycloalkenyl, alkynyl, heterocycle, or aryl; each occurrence of R_{b}, R_{c} and R_{d} is independently hydrogen, alkyl, cycloalkyl, heterocycle, aryl, or said R_{b} and R_{c} together with the N to which they are bonded optionally form a heterocycle; and each occurrence of Rₑ is independently alkyl, cycloalkyl, alkenyl, cycloalkenyl, alkynyl, heterocycle, or aryl. In the aforementioned exemplary substitutents, groups such as alkyl, cycloalkyl, alkenyl, alkynyl, cycloalkenyl, heterocycle and aryl can themselves be optionally substituted.

The term “alkenyl” refers to a straight or branched chain hydrocarbon radical containing from 2 to 12 carbon atoms and at least one carbon-carbon double bond. Exemplary such groups include ethenyl or allyl. The term “C₂-C₆ alkenyl” refers to a straight or branched chain hydrocarbon radical containing from 2 to 6 carbon atoms and at least one carbon-carbon double bond, such as ethylenyl, propenyl, 2-propenyl, (E)-but-2-enyl, (Z)-but-2-enyl, 2-methy(E)-but-2-enyl, 2-methy(Z)-but-2-enyl, 2,3-dimethy-but-2-enyl, (Z)-pent-2-enyl, (E)-pent-1-enyl, (Z)-hex-1-enyl, (E)-pent-2-enyl, (Z)-hex-2-enyl, (E)-hex-2-enyl, (Z)-hex-1-enyl, (E)-hex-1-enyl, (Z)-hex-3-enyl, (E)-hex-3-enyl, and (E)-hex-1,3-dienyl. “Substituted alkenyl” refers to an alkenyl group substituted with one or more substituents, preferably 1 to 4 substituents, at any available point of attachment. Exemplary substituents include but are not limited to one or more of the following groups: hydrogen, halogen (e.g., a single halogen substituent or multiple halo substitutents forming, in the latter case, groups such as CF₃ or an alkyl group bearing CCl₃), cyano, nitro, oxo (i.e., ═O), CF₃, OCF₃, cycloalkyl, alkenyl, cycloalkenyl, alkynyl, heterocycle, aryl, OR, SR, S(═O)Rₑ, S(═O)₂Rₑ, P(═O)₂Rₑ, S(═O)₂ORₑ, P(═O)₂ORₑ, NR_{b}R_{c}, NR_{b}S(═O)₂Rₑ, NR_{b}P(═O)₂Rₑ, S(═O)₂NR_{b}R_{c}, P(═O)₂NR_{b}R_{c}, C(═O)OR_{d}, C(═O)Rₐ, C(═O)NR_{b}R_{c}, OC(═O)R, OC(═O)NR_{b}R_{c}, NR_{b}C(═O)ORₑ, NR_{d}C(═O)NR_{b}R_{c}, NR_{d}S(═O)₂NR_{b}R_{c}, NR_{d}P(═O)₂NR_{b}R_{c}, NR_{b}C(═O)Rₐ, or NR_{b}P(═O)₂Rₑ, wherein each occurrence of Rₐ is independently hydrogen, alkyl, cycloalkyl, alkenyl, cycloalkenyl, alkynyl, heterocycle, or aryl; each occurrence of R_{b}, R_{c} and R_{d} is independently hydrogen, alkyl, cycloalkyl, heterocycle, aryl, or said R_{b} and R_{c} together with the N to which they are bonded optionally form a heterocycle; and each occurrence of Rₑ is independently alkyl, cycloalkyl, alkenyl, cycloalkenyl, alkynyl, heterocycle, or aryl. The exemplary substitutents can themselves be optionally substituted.

The term “cycloalkyl” refers to a fully saturated cyclic hydrocarbon group containing from 1 to 4 rings and 3 to 8 carbons per ring. “C₃-C₇ cycloalkyl” refers to cyclopropyl, cyclobutyl, cyclopentyl, cyclohexyl, or cycloheptyl. “Substituted cycloalkyl” refers to a cycloalkyl group substituted with one or more substituents, preferably 1 to 4 substituents, at any available point of attachment. Exemplary substituents include but are not limited to one or more of the following groups: hydrogen, halogen (e.g., a single halogen substituent or multiple halo substitutents forming, in the latter case, groups such as CF₃ or an alkyl group bearing CCl₃), cyano, nitro, oxo (i.e., ═O), CF₃, OCF3, cycloalkyl, alkenyl, cycloalkenyl, alkynyl, heterocycle, aryl, OR, SR, S(═O)Rₑ, S(═O)₂Rₑ, P(═O)₂Rₑ, S(═O)₂OR, P(═O)₂ORₑ, NR_{b}R_{c}, NR_{b}S(═O)₂Rₑ, NR_{b}P(═O)₂Rₑ, S(═O)₂NR_{b}R_{c}, P(═O)₂NR_{b}R_{c}, C(═O)OR_{d}, C(═O)R, C(═O)NR_{b}R_{c}, OC(═O)R, OC(═O)NR_{b}R_{c}, NR_{b}C(═O)ORₑ, NR_{d}C(═O)NR_{b}R_{c}, NR_{d}S(═O)₂NR_{b}R_{c}, NR_{d}P(═O)₂NR_{b}R_{c}, NR_{b}C(═O)Rₐ, or NR_{b}P(═O)₂Rₑ, wherein each occurrence of Rₐ is independently hydrogen, alkyl, cycloalkyl, alkenyl, cycloalkenyl, alkynyl, heterocycle, or aryl; each occurrence of R_{b}, Rₑ and R_{d} is independently hydrogen, alkyl, cycloalkyl, heterocycle, aryl, or said R_{b} and Rₑ together with the N to which they are bonded optionally form a heterocycle; and each occurrence of Rₑ is independently alkyl, cycloalkyl, alkenyl, cycloalkenyl, alkynyl, heterocycle, or aryl. The exemplary substitutents can themselves be optionally substituted. Exemplary substituents also include spiro-attached or fused cyclic substituents, especially spiro-attached cycloalkyl, spiro-attached cycloalkenyl, spiro-attached heterocycle (excluding heteroaryl), fused cycloalkyl, fused cycloalkenyl, fused heterocycle, or fused aryl, where the aforementioned cycloalkyl, cycloalkenyl, heterocycle and aryl substitutents can themselves be optionally substituted.

The terms “heterocycle” and “heterocyclic” refer to fully saturated, or partially or fully unsaturated, including aromatic (i.e., “heteroaryl”) cyclic groups (for example, 4 to 7 membered monocyclic, 7 to 11 membered bicyclic, or 8 to 16 membered tricyclic ring systems) which have at least one heteroatom in at least one carbon atom-containing ring. Each ring of the heterocyclic group containing a heteroatom may have 1, 2, 3, or 4 heteroatoms selected from nitrogen atoms, oxygen atoms and/or sulfur atoms, where the nitrogen and sulfur heteroatoms may optionally be oxidized and the nitrogen heteroatoms may optionally be quaternized.

“Substituted heterocycle” and “substituted heterocyclic” (such as “substituted heteroaryl”) refer to heterocycle or heterocyclic groups substituted with one or more substituents, preferably 1 to 4 substituents, at any available point of attachment. Exemplary substituents include but are not limited to one or more of the following groups: hydrogen, halogen (e.g., a single halogen substituent or multiple halo substitutents forming, in the latter case, groups such as CF₃ or an alkyl group bearing CCl₃), cyano, nitro, oxo (i.e., ═O), CF₃, OCF₃, cycloalkyl, alkenyl, cycloalkenyl, alkynyl, heterocycle, aryl, OR, SR, S(═O)Rₑ, S(═O)₂Rₑ, P(═O)₂Rₑ, S(═O)₂ORₑ, P(═O)₂ORₑ, NR_{b}R_{c}, NR_{b}S(═O)₂Rₑ, NR_{b}P(═O)₂Rₑ, S(═O)₂NR_{b}R_{c}, P(═O)₂NR_{b}R_{c}, C(═O)OR_{d}, C(═O)Rₐ, C(═O)NR_{b}R_{c}, OC(═O)Rₐ, OC(═O)NR_{b}R_{c}, NR_{b}C(═O)ORₑ, NR_{d}C(═O)NR_{b}R_{c}, NR_{d}S(═O)₂NR_{b}R_{c}, NR_{d}(═O)₂NR_{b}R_{c}, NR_{b}C(═O)Rₐ, or NR_{b}P(═O)₂Rₑ, wherein each occurrence of Rₐ is independently hydrogen, alkyl, cycloalkyl, alkenyl, cycloalkenyl, alkynyl, heterocycle, or aryl; each occurrence of R_{b}, R_{c} and R_{d} is independently hydrogen, alkyl, cycloalkyl, heterocycle, aryl, or said R_{b} and R_{c} together with the N to which they are bonded optionally form a heterocycle; and each occurrence of Rₑ is independently alkyl, cycloalkyl, alkenyl, cycloalkenyl, alkynyl, heterocycle, or aryl. The exemplary substitutents can themselves be optionally substituted. Exemplary substituents also include spiro-attached or fused cyclic substituents at any available point or points of attachment, especially spiro-attached cycloalkyl, spiro-attached cycloalkenyl, spiro-attached heterocycle (excluding heteroaryl), fused cycloalkyl, fused cycloalkenyl, fused heterocycle, or fused aryl, where the aforementioned cycloalkyl, cycloalkenyl, heterocycle and aryl substituents can themselves be optionally substituted.

The terms “halogen” or “halo” refer to chlorine, bromine, fluorine or iodine.

The compounds of the present invention may form salts which are also within the scope of this invention. Reference to a compound of the present invention is understood to include reference to salts thereof, unless otherwise indicated. The term “salt(s)”, as employed herein, denotes acidic and/or basic salts formed with inorganic and/or organic acids and bases. In addition, when a compound of the present invention contains both a basic moiety, such as but not limited to a pyridine or imidazole, and an acidic moiety such as but not limited to a carboxylic acid, zwitterions (“inner salts”) may be formed and are included within the term “salt(s)” as used herein. Pharmaceutically acceptable (i.e., non-toxic, physiologically acceptable) salts are preferred, although other salts are also useful, e.g., in isolation or purification steps which may be employed during preparation. Salts of the compounds of the present invention may be formed, for example, by reacting a compound I with an amount of acid or base, such as an equivalent amount, in a medium such as one in which the salt precipitates or in an aqueous medium followed by lyophilization.

The compounds of the present invention which contain an acidic moiety, such but not limited to a carboxylic acid, may form salts with a variety of organic and inorganic bases. Exemplary basic salts include ammonium salts, alkali metal salts such as sodium, lithium and potassium salts, alkaline earth metal salts such as calcium and magnesium salts, salts with organic bases (for example, organic amines) such as benzathines, dicyclohexylamines, hydrabamines (formed with N,N-bis(dehydroabietyl) ethylenediamine), N-methyl-D-glucamines, N-methyl-D-glycamides, t-butyl amines, and salts with amino acids such as arginine, lysine and the like. Basic nitrogen-containing groups may be quaternized with agents such as lower alkyl halides (e.g., methyl, ethyl, propyl, and butyl chlorides, bromides and iodides), dialkyl sulfates (e.g., dimethyl, diethyl, dibutyl, and diamyl sulfates), long chain halides (e.g., decyl, lauryl, myristyl and stearyl chlorides, bromides and iodides), aralkyl halides (e.g., benzyl and phenethyl bromides), and others.

Solvates of the compounds of the invention are also contemplated herein. Solvates of the compounds of the present invention include, for example, hydrates.

Compounds of the present invention, and salts or solvates thereof, may exist in their tautomeric form (for example, as an amide or imino ether). All such tautomeric forms are contemplated herein as part of the present invention.

All stereoisomers of the present compounds (for example, those which may exist due to asymmetric carbons on various substituents), including enantiomeric forms and diastereomeric forms, are contemplated within the scope of this invention. Individual stereoisomers of the compounds of the invention may, for example, be substantially free of other isomers (e.g., as a pure or substantially pure optical isomer having a specified activity), or may be admixed, for example, as racemates or with all other, or other selected, stereoisomers. The chiral centers of the present invention may have the S or R configuration as defined by the International Union of Pure and Applied Chemistry (IUPAC) 1974 Recommendations. The racemic forms can be resolved by physical methods, such as, for example, fractional crystallization, separation or crystallization of diastereomeric derivatives or separation by chiral column chromatography. The individual optical isomers can be obtained from the racemates by any suitable method, including without limitation, conventional methods, such as, for example, salt formation with an optically active acid followed by crystallization.

It is contemplated that any embodiment disclosed herein may be properly combined with any other embodiment disclosed herein. The combination of any two or more embodiments disclosed herein is expressly contemplated.

### BRIEF DESCRIPTION OF DRAWINGS

The invention is described with reference to the following figures, which are presented for the purpose of illustration only and are not intended to be limiting.

FIG. 1 is a schematic of the tamper-indicating device used to record the opening of a sealed container according to one or more embodiments described herein.

FIG. 2 illustrates a mechanism of the melanin synthesis reaction that underlies the function of Bio-Inspired Oxygen-Indicating Device (BIO-ID) according to one or more embodiments described herein, where the responsive material is deoxygenated L-DOPA in a weakly alkaline solution and oxygen catalyzes its instantaneous, irreversible polymerization to form the dark, melanin pigment.

FIG. 3 illustrates a UV spectrum showing that hydroxyquinone oxidation causes an increase in absorbance intensity in the UV range (350-750 nm), according to one or more embodiments described herein.

FIG. 4A shows the top and cross-section views of a schematic cross-section of the artificial melanosome temper indicating device including a glass depression slide coated with a selectively permeable silicone rubber (PDMS) with a DOPA-melanin filled pocket, according to one or more embodiments described herein.

FIG. 4B shows artificial melanosomes temper indicating device inside of sealed jars saturated with nitrogen gas, where the leftmost jar has been previously opened and the artificial melanosome changes from pale yellow (0 hrs) to orange (2 hrs) (eventually to black as shown in FIG. 4A), according to one or more embodiments described herein.

FIG. 5A presents representative optical images of a sample with thickness=0.874 mm showing the time-dependent color shift associated with the oxidative polymerization of L-DOPA, according to one or more embodiments described herein.

FIG. 5B presents the normalized absorbance (550-552 nm) through artificial melanosomes where the distances represent the thickness of the top PDMS layer through which oxygen diffuses, according to one or more embodiments described herein.

FIG. 5C shows a response time-thickness relationship graph where the response time is the time at which the extent of the color change for each melanosome has resulted in an optical transmittance of less than 50%, according to one or more embodiments described herein.

FIG. 5D shows an oxygen-diffusion rate-thickness relationship graph where the oxygen diffusion rate is the rate of the time response or color change produced by a melanosome of a given thickness, according to one or more embodiments described herein.

FIG. 6A shows the absorbance intensity of deoxygenated DOPA-KOH precursor solution at 297 nm and averaged between 450-490 nm, measured for 40 days, according to one or more embodiments described herein.

FIG. 6B shows the schematics on the method to determine potential leaching of DOPA-melanin into surrounding media, according to one or more embodiments described herein.

FIG. 6C shows the fluorescence intensity of DI water samples in which artificial melanosomes containing DOPA-melanin and PDMS encapsulation to thicknesses of 3.5 mm and 0.2 mm were submerged, according to one or more embodiments described herein.

FIG. 6D shows an enraged portion of FIG. 6C, showing that the fluorescence intensity of DI water samples in which artificial melanosomes containing DOPA-melanin and PDMS encapsulation to thicknesses of 3.5 mm and 0.2 mm were submerged, according to one or more embodiments described herein.

FIGS. 7A and 7B show the HPLC analysis of DOPA-KOH leaching from within artificial melanosomes submerged in DI water with thicknesses of 3.5 mm and 0.2 mm, by determining UV absorption at wavelength 340 nm and 297 nm, respectively, according to one or more embodiments described herein. FIGS. 7C and 7D show the HPLC analysis of DOPA-melanin leaching from within artificial melanosomes submerged in DI water with thicknesses of 3.5 mm and 0.2 mm, by determining UV absorption at wavelength 340 nm and 297 nm, respectively, according to one or more embodiments described herein.

FIG. 8 illustrates a Fourier transform infrared spectral comparison of L-DOPA (dotted line) and DOPA-melanin (solid line), according to one or more embodiments described herein.

FIG. 9 shows devices 1-3 with the first oxygen-sensitive compound embedded at the 2.20, 3.70, and 5.60 mm, respectively, below the surface of the casing (a PDMS top layer), according to one or more embodiments described herein

### DETAILED DESCRIPTION

The foregoing and other features and advantages of various aspects of the invention(s) will be apparent from the following, more-particular description of various concepts and specific embodiments within the broader bounds of the invention(s). Various aspects of the subject matter introduced above and discussed in greater detail below may be implemented in any of numerous ways, as the subject matter is not limited to any particular manner of implementation. Examples of specific implementations and applications are provided primarily for illustrative purposes.

In one aspect, a tamper-indicating device is described, including a casing having a gas-permeable surface that allows a particular gas to permeate into the casing; and a first gas-sensitive compound encapsulated within the casing at a depth below the surface and configured to, upon exposure to the gas, provide a visual response. In some embodiments, the first gas-sensitive compound irreversibly changes to an indicator compound with a color different from the color of the first gas-sensitive compound upon exposure to the gas.

In some embodiments, the casing is made of a material which is intrinsically permeable to the gas. Non-limiting examples of such materials include certain polymers known in the art, e.g., poly(chloroprene) (neoprene), poly(vinyl chloride), polydimethyl siloxane (PDMS), low density polyethylene (LDPE), high density polyethylene (HDPE), poly(methyl methacrylate), polypropylene (PP), polycarbonate (PC), cellulose acetate butyrate, a blend of PMMA and CAB with silicone networks, poly (hydroxyethyl methacrylate) hydrogels, and amorphous and semicrystalline poly (vinyl alcohol) hydrogels, which have gas (e.g., oxygen) permeability and can be used to make the casing described herein. In some embodiments, the permeability coefficients of the casing is from about 0.1×10⁻¹⁰ cm³(STP)·cm/sec·cm²·cmHg to about 100×10⁻¹⁰ cm³(STP)·cm/sec·cm²·cmHg. In some embodiments, the permeability coefficients of the casing is about 0.1×10¹⁰, 1.0×10⁻¹⁰, 2.0×10⁻¹⁰, 5.0×10⁻¹⁰, 10.0×10⁻¹⁰, 20.0×10⁻¹⁰, 30.0×10⁻¹⁰, 40.0×10⁻¹⁰, 50.0×10⁻¹⁰, 60.0×10⁻¹⁰, 70.0×10⁻¹⁰, 80.0×10⁻¹⁰, 90.0×10⁻¹⁰, or 100.0×10⁻¹⁰ cm³(STP)·cm/sec·cm²·cmHg, or in any range bounded by any two values described herein.

The casing may be porous, e.g., containing one or more pores, to allow the gas to permeate into the casing. Alternatively, the surface can be constructed, e.g., cut, to form one or more openings to allow the gas, to permeate into the casing. In certain embodiments, the pores or openings have an average diameter of about 50 nm, 100 nm, 500 nm, 1000 nm, 2000 nm, 3000 nm, 4000 nm, or 5000 nm, or in any range bounded by any two values described herein. In some embodiments, the openings may be the shape of a circle, a line, a rectangular, or in any regular or irregular shapes known in the art. In some embodiments, the gas permeability of the gas-permeable surface can be tuned to adjust the time-range of exposure for which the first gas-sensitive compound (e.g., a first oxygen-sensitive compound) is most sensitive. For instance, the casing material can be changed to result in different gas-permeability or the pore sizes of the surface can be adjusted. Similarly, the sizes of the openings on the surface can be adjusted as well to fine-tune the gas-permeability of the surface.

In some embodiments, the casing or its surface may also prevent the first gas (e.g., oxygen)-sensitive compound or the indicator compound from permeating out of the casing to contaminate the product within the package. In one or more embodiments, a gas (e.g., oxygen) permeable protective coating can be used to improve stability of the tamper-indicating device.

The tamper-indicating device may be sealed in a package containing a product. The atmosphere inside the package may be substantially free of the gas so that the first gas-sensitive compound does not change into the indicator compound. In some embodiments, the atmosphere inside the package may contain less than 20%, 15%, 10%, 5%, 1%, or 0.1% of the gas (e.g., oxygen) or may have the gas in any range of percentages bounded by any two values of percentage disclosed herein. In some embodiments, the package may contain one or more gas-scavenger (e.g., antioxidant) to capture residual gas in the package. Any gas-scavenger known in the art may be used. The amount of the gas-scavenger is carefully controlled to be sufficient to capture residual gas but not in excess to interfere with detecting future exposure to the gas as a result of tampering. In some embodiments, the atmosphere inside the package contains the gas, e.g., oxygen, in about 19.5%-23.5%. In some specific embodiments, gas level dissolved in the product, e.g., wine, is about 6-9 mg/L. In some specific embodiments, oxygen levels dissolved in red and white wines is about less than 1.25 mg/L and 0.6 mg/L, respectively. In other embodiments, the first oxygen-sensitive compound may be included in the package in an amount sufficient to capture the residual oxygen in the package and to indicate future tampering.

In some embodiments, in order to facilitate observing the color of the compound encapsulated within the casing, the casing surface and/or the package of the product are at least partially transparent to allow a user or consumer to observe the color of the compound. For instance, the casing or a part thereof can be transparent so that a user or consumer can see through the surface (or part of the surface) to see the color of the compound underneath. In other embodiments, the surface is not transparent and the color of the compound (e.g., the first oxygen-sensitive compound or the indicator compound) can be observed through the pores or the openings on the surface. In still other embodiments, at least part of the package including the product can be transparent to allow a user or consumer to observe the tamper-indicating device and the color of the compound encapsulated therein. In these embodiments, if needed, the product itself may still remain covered by other parts of the package to conceal the identity of the product.

In some embodiments, the first gas (e.g., oxygen)-sensitive compound has a color lighter or darker than the indicator compound. In certain specific embodiments, the degree of the color change is proportional to the amount of the gas that the first gas-sensitive compound was exposed to, which in turn may indicate the length of the time during which the package was opened. In certain embodiments, a standard chart or graph may be provided indicating the relationship between the color of the compound encapsulated in the casing and the length of the time during which the package was opened. Using this chart or graph, one may determine how long the package has been opened based on the color observed for the compound embedded in the casing. In some embodiments, the first gas-sensitive compound is colorless and the indicator compound has a yellow, brown, or black color.

In certain embodiments, the first gas-sensitive compound is stable and non-reactive under an inert atmosphere (i.e., an atmosphere without the gas that the first gas-sensitive compound is sensitive to) and can therefore endure the functional lifetime of a packaged product.

In certain embodiments, the product within the package may contain a liquid medium. In these embodiments, the surface of the casing may be configured to be impermeable to the liquid medium of the product so that the liquid medium is not contaminated with the first gas-sensitive compound encapsulated within casing. For instance, the product may be an aqueous liquor product, e.g., a wine, and the surface of the casing is water-impermeable. In some embodiments, the surface of the casing is hydrophobic. In certain embodiments, the casing's surface is made of rubber, e.g., silicone. In some specific embodiments, the casing is a silicone film. Other non-limiting exemplary materials for the water-impermeable surface include hydrophobic polymers including, but not limited to, polyurethanes, acrylics (e.g., PMMA), esters (e.g., PET), carbonates (e.g., poly-BPA carbonate), amides/imides (e.g., nylon 6/6), olefins (e.g., polypropylenes, polyethylenes), polyethers, fluorocarbons, and styrenes. In other embodiments, the product may be an oil product, e.g., cooking oil, and the surface of the casing is oil-impermeable. In some embodiments, the surface of the casing is hydrophilic. In certain embodiments, the casing's surface is made of hydrophilic polymers. Non-limiting exemplary materials for the oil-impermeable surface include hydrophilic polymers including, but not limited to, polyacrylamide, certain acrylics (e.g., polyacrylic acids, polymethacrylate), polyethylene glycol, polyvinyl alcohol, and polyelectrolytes.

In some embodiments, the first gas-sensitive compound is encapsulated within the casing. For instance, a solution of the first gas-sensitive compound can be injected into a solid casing block. Alternatively, one or more pockets can be created inside the casing and the solution of the first gas-sensitive compound may be added into the pocket and the surface can be then resealed. In other embodiments, the polymer or its precursor for making the casing can be mixed with the first gas-sensitive compound to form the casing. In some specific embodiments, the polymer precursor is partially cured and the first gas-sensitive compound is injected into the polymer to form a pocket. In other embodiments, a polymer precursor and the immiscible gas-sensitive are mixed and emulsified, creating a quasi-homogeneous material with many small gas-sensitive “bubbles” or “pockets” dispersed evenly within. The whole sample is then fully cured creating an encapsulated device with no large pores from injection.

In certain embodiments, the first gas-sensitive compound is encapsulated at a depth of about 0.1-20 mm beneath the casing's surface. The depth or the thickness of the casing may be about 0.1, 0.5, 1, 2, 3, 4, 5, 6, 7, 8, 9, 10, or 20 mm, or in any range bounded by any two values disclosed herein. In some specific embodiments, the depth is about 5-10 mm, e.g., 2.2 mm, 3.7 mm, or 5.6 mm. In some embodiments, the depth at which the first gas-sensitive compound is embedded or encapsulated within the casing can be adjusted to fine-tune the sensitivity of the tamper-detecting. As described herein, the extent of color change of the compound provides a measure of how much gas the tamper-indicating device has been exposed to, and by extension, for how long the package of the product was open. In some embodiments, the depth can be tuned to adjust the time-range of exposure for which the first gas-sensitive compound is most sensitive. This time-sensitivity can be tuned over a broad spectrum ranging from a few seconds (as the depth approaches 0) to several hours for a depth or thickness of ˜5-10 mm. In some embodiments, an extended range of sensitivity can be achieved by embedding multiple gas-sensitive compounds (which can be the same or different) at different depths within a casing.

In certain embodiments, the response of the first gas-sensitive compound is adjusted to delay until a predetermined time period after the sealed container containing the device has been opened. In some embodiments, the predetermined time period is about 1 min, 5 min, 10 min, 15 min, 20 min, 30 min, 1 h, 2 h, or 5 h, or in a range bounded by any two values disclosed herein. In certain embodiments, the predetermined delay time can be adjusted by adjusting the thickness of the casing (or the embedding depth of the first gas-sensitive compound). Thus, separately adjusting the size of the reagent pocket and the gas-permeable membrane thickness allows determination of the response time and sensitivity to be decoupled. The ability to engineer long delay times for highly sensitive responses provides an added level of covertness. Delaying response until long after the container has been opened, tampered with and re-sealed would keep the response hidden from the perpetrator.

In certain embodiments, the first gas-sensitive compound can be oxidized when exposed to the gas to form the indicator compound. In other embodiments, the first gas-sensitive compound undergoes polymerization catalyzed by gas to form the indicator compound which is a polymer. Other example of oxygen-sensitive compound is perylene diimide. Additional examples of gas-sensitive compounds are described in PCT/US2015/025408, filed Apr. 10, 2015, the content of which is expressly incorporated by reference.

In certain embodiments, the first gas-sensitive compound and/or the indicator compound are non-toxic and safe for human consumption.

In certain embodiments, the gas is one or more selected from the group consisting of oxygen, CO, CO₂, toxic gas such as nerve gas (e.g., phosgene), water vapor, HCl, H₂S, SO₂, NO₂, NH₃, O₃, NO and a combination thereof. In any embodiments described herein, the gas may be oxygen. As illustrated below, oxygen is used as a non-limiting example of the gases. However, the use of other gases known in the art is contemplated. In certain embodiments, the gas is CO₂ and the first gas-sensitive compound is a first CO₂-sensitive compound. Non-limiting examples of the first CO₂-sensitive compound include organic and inorganic bases, e.g., amines, which are optionally functionalized on solid support. In certain embodiments, the gas is phosgene and the first gas-sensitive compound is a first phosgene-sensitive compound. Non-limiting examples of the first phosgene-sensitive compound include Harrison's reagent (mixture of 4-(N,N-dimethylamino)benzaldehyde and diphenylamine and a mixture of 4-(N,N-dimethylamino)benzaldehyde and N,N-dialkylanilines. In certain embodiments, the gas is water vapor and the first gas-sensitive compound is a first water vapor-sensitive compound. Non-limiting examples of the first water vapor-sensitive compound include pH indicators that are tuned to around the pH of rainwater (5.5) or pure water (7). Non-limiting examples include Bromothymol blue, Bromocresol purple, Phenol red, and Neutral red. Other examples are described in WO2014078577, and EP2831576, the contents of which are expressly incorporated by reference. In certain embodiments, the gas is carbon monoxide (CO) and the first gas-sensitive compound is a first CO-sensitive compound. Non-limiting examples of the first CO-sensitive compound include cyclodextrins and hemoglobin, binuclear rhodium complexes (e.g., [Rh₍₂₎{(XC₍₆₎H₍₃₎)P(XC₍₆₎H₍₄₎)}₍ₙ₎(O₍₂₎CR)₍₄₋ₙ₎].L₍₂₎. Other examples of suitable gases are described in Zhou et al., Recent Progress on the Development of Chemosensors for Gases, Chem. Rev., Article ASAP, 2015 (http://pubs.acs.org/doi/full/10.1021/cr500567r), the content of which is expressly incorporated by reference.

In some embodiments, the tamper-indicating device includes one or more gas-sensitive compounds encapsulated within the gas-permeable casing and each selected to provide visual response upon exposure to a gas, in addition to the first gas-sensitive compound. Thus, the device as described herein may include two or more gas-sensitive compounds. These gas-sensitive compounds may be selected to be sensitive to and thus react with the same gas. Alternatively, in certain embodiments, these gas-sensitive compounds may be selected to be sensitive to and thus react with different gases and thus the device may be used to detect the exposure of the product to more than one type of gas. In some embodiments, the one or more gas-sensitive compounds and the first gas-sensitive compound are encapsulated at the same depth below the surface of the casing. In some embodiments, the one or more gas-sensitive compounds and the first gas-sensitive compound are encapsulated at different depths below the surface of the casing.

In some embodiments, the first gas-sensitive compound is a first oxygen-sensitive compound selected from the group consisting of catecholamines and precursors for biological catecholamines (e.g., epinephrine, dopamine, norepinephrine). In some specific embodiments, the first oxygen-sensitive compound is a precursor, e.g., a synthetic precursor, of melanin and the indicator compound is melanin. In some specific embodiments, the first oxygen-sensitive compound is an artificial melanosome. In other embodiments, the first oxygen-sensitive compound has the structure of formula (I), a salt, or a hydrate thereof,

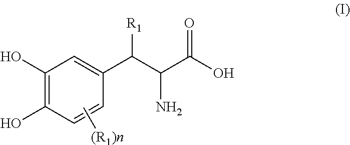

wherein n is 0, 1, 2, or 3, each occurrence of R₁ is independently selected from the group consisting of H, halogen, alkyl, alkenyl, cycloalkyl, alkylcycloalkyl, OH, SH, ORₐ, O(C═O)Rₐ, (C═O)ORₐ, (C═O)Rₐ, NH₂, NO₂, NRₐR_{b}, NRₐ(C═O)R_{b}, (C═O)NRₐR_{b}, NRₐ(C═O)OR_{b}, and O(C═O)NRₐR_{b}, wherein each occurrence of Rₐ and R_{b} is independently selected from the group consisting of H, halogen, alkyl, and cycloalkyl, or alternatively Rₐ and R_{b}, when connected to N, taken together with the nitrogen atom to which they are connected form a heterocycle comprising 1-4 heteroatoms, which may be optionally substituted by from one to four groups which may be the same or different (C₁-C₄)alkyl. In certain embodiments, R₁ is H and the oxygen-sensitive compound is 3,4-dihydroxyphenylalanine (L-DOPA). In other embodiments, R₁ is OH, alkyl, ORₐ, NH₂, or NRₐR_{b}. In other embodiments, R₁ is (C═O)Rₐ or NO₂.

In some embodiments, the oxygen-sensitive compound of formula (I) may undergo oxidation and/or polymerization reactions to form an indole compound of formula (II) (Scheme 1). In these instances, the electron-donating/withdrawing properties of R₁ substituent may affect the reaction speed and sensitivity of the oxygen-sensitive compound with oxygen. For instance, without wishing to be bound by any particular theory, it is believed that an electron-donating group such as OH, alkyl, ORₐ, NH₂, or NRₐR_{b} may slow down the indole formation step while an electron-withdrawing group such as (C═O)Rₐ or NO₂ may facilitate the indole formation step. Thus, the sensitivity of the tamper-indicating device may be further fine-tuned by the selection of different R₁ groups.

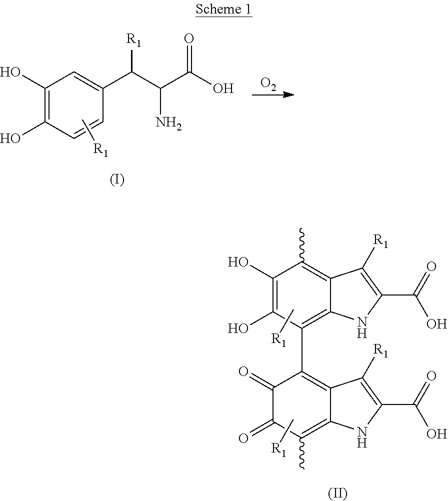

In certain embodiments, the first oxygen-sensitive compound in the device has an amount of less than about 20 μmol, 15 μmol, 10 μmol, 9 μmol, 8 μmol, 7 μmol, 6 μmol, 5 μmol, 4 μmol, 3 μmol, 2 μmol, or 1 μmol, or in a range bounded by any two values disclosed herein.

In another aspect, a method of detecting tampering of a product or exposure of the product to a gas is described, including sealing the tamper-indicting device described herein with a product in a package substantially free of the gas therein. For instance, the atmosphere inside the package may contain less than 10%, 9%, 8%, 7%, 6%, 5%, 4%, 3%, 2%, or 1% of the gas, or contain the gas in any range bounded by any value disclosed herein. In some embodiments, a user or consumer may inspect the tamper-indicating device in the package and an appearance of the color of the indicator compound indicates prior tampering of the package or the exposure of the interior of the package to the gas. In some instance, the user may open the package to examine the color of the compound encapsulated in the casing. In other embodiments, the package and/or the surface of the casing is at least partially transparent to allow a user to examine the color of the first gas-sensitive compound or the indicator compound without opening the package.

The device described according to one or more embodiments is now illustrated using oxygen as a non-liming example of the gas.

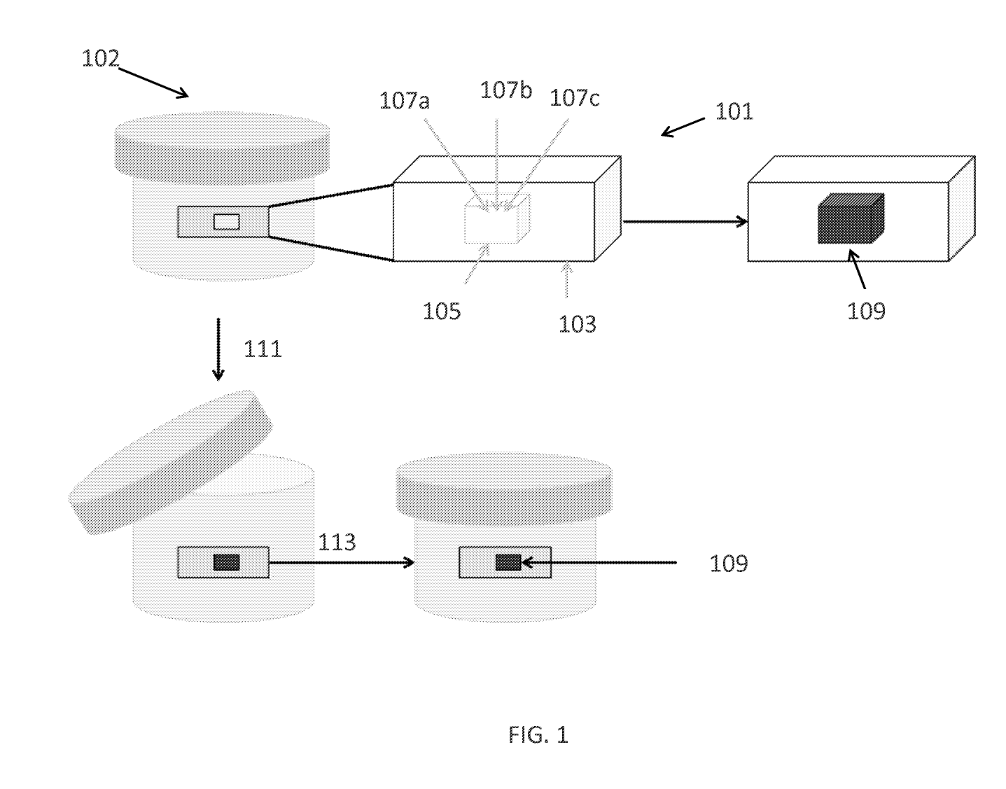

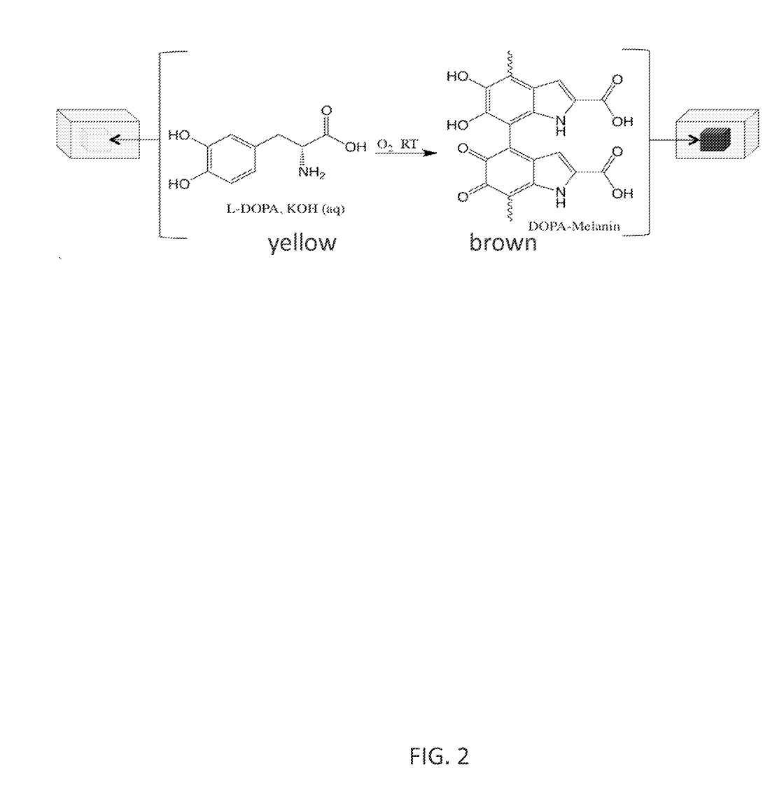

An exemplary tamper-indicating device 101, e.g., a Bio-Inspired Oxygen-Indicating device (BIO-ID), is described with reference to FIG. 1. As shown in FIG. 1, the device 101 includes a gas-permeable rubber casing 103 that contains one or more oxygen-sensitive compound 105, e.g., “artificial melanosomes,” pockets of the transparent deoxygenated precursors to synthetic melanin (an example of the indicator compound), a colored biopolymer from the same family of pigments that are found in our bodies. When the film is exposed to oxygen, diffusion of the gas through the permeable rubber layer from various directions (indicated by arrows 107a-c) exposes the melanin precursors 105 and catalyzes the synthesis of the melanin pigment 109 (which is an irreversible process). Melanin synthesis proceeds via the spontaneous polymerization of 3,4-dihydroxyphenylalanine (L-DOPA) under weakly alkaline conditions (see, e.g., FIG. 2) and gives a dark brown, melanin-like pigment 109 (herein referred to as DOPA-melanin) upon exposure to oxygen. The device 101 is placed in a sealed container 102. Thus, if the container has been opened (step 111), oxygen gets into the container and through the casing 103 to trigger the irreversible synthesis of pigment resulting in a stark color change 109. Even if the container is subsequently re-sealed (step 113), the colored pigment 109 will indicate prior tempering of the sealed container. In certain embodiments, the extent of the irreversible synthesis of pigment, indicated by the darkness of the color of the pigment, provides information on the length of time that the package was exposed to air.

The tamper-indicating device described herein provides a highly sensitive and irreversible colorimetric response to oxygen without using highly toxic compounds. In some embodiments, the precursor contained within the device includes bio-inspired artificial melanosome in a weakly basic solution (pH ˜8-9) of an amino acid derivative that is found naturally in our bodies (L-DOPA). Furthermore, the oxygen gas-permeable casing, e.g., rubber enclosure, provides a selective barrier that allows oxygen to permeate, while preventing leaching of any compounds from the oxygen-sensitive region. The outer casing can be made of non-toxic rubbers such as silicone, which are already commonly used in medical implants inside the body as well as many household items.

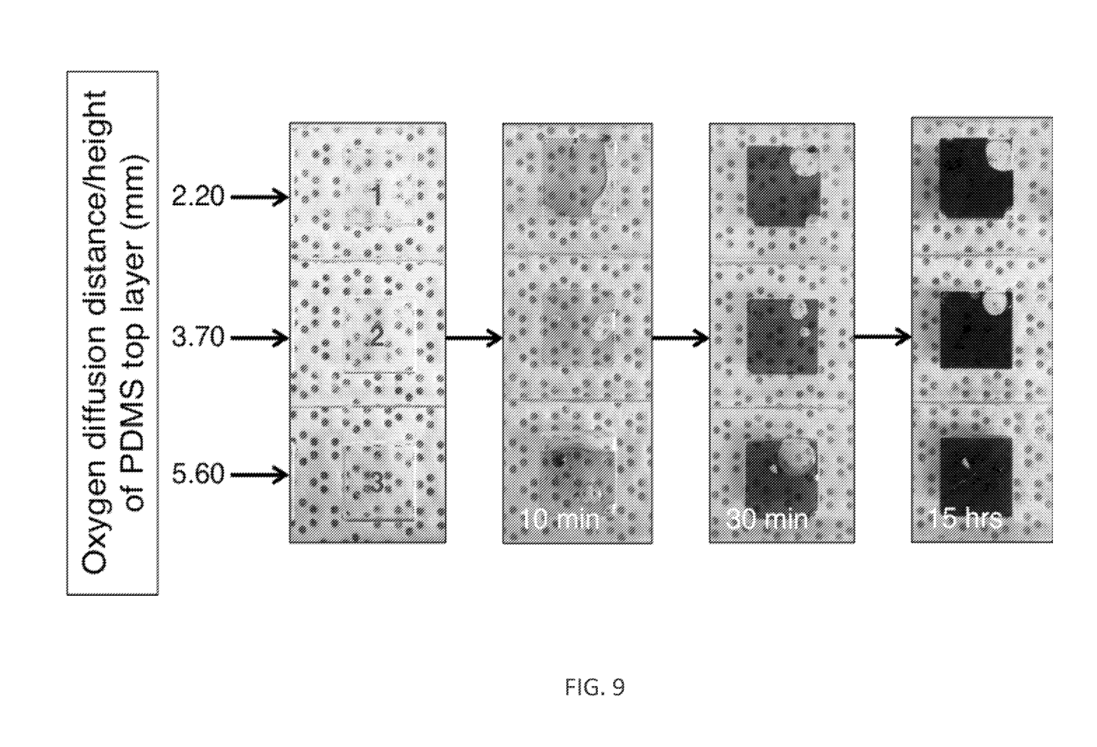

The extent of color change provides a measure of how much oxygen the film has been exposed to, and by extension, for how long the package was open. The thickness or gas permeability of the oxygen-permeable rubber layer can be tuned to adjust the time-range of exposure for which the artificial melanosome is most sensitive. This time-sensitivity can be tuned over a broad spectrum ranging from a few seconds (as the thickness approaches 0) to several hours for a thickness of ˜5-10 mm (see FIG. 9). FIG. 9 shows devices 1-3 with the first oxygen-sensitive compound embedded at the 2.20, 3.70, and 5.60 mm, respectively, below the surface of the casing, e.g., a PDMS top layer. In certain embodiments, an extended range of sensitivity can be achieved by embedding multiple artificial melanosomes at different depths within a single film.

An exemplary method of fabricating the tamper-indicating device is now described. Artificial melanosomes are fabricated by either injecting a weakly basic aqueous L-DOPA solution into a rubber film containing pre-made pockets or directly into uncured rubber precursors. Rubber films containing pockets with arbitrary sizes, shapes and depths can be fabricated using well-known 3D printing, molding, and bonding techniques. All fabrication steps are performed in an oxygen-free environment and all reagents are de-gassed and purged with inert gas to remove any residual dissolved oxygen.

### Experiment

In one embodiment, we describe a non-toxic surface coating that reports oxygen exposure through irreversible formation of colored spots. The device consists of a selectively permeable rubber film that contains the colorless organic precursors to darkly pigmented synthetic melanin. Melanin synthesis is triggered by exposure to molecular oxygen. The selectively permeable rubber film regulates the rate of oxygen diffusion, enabling independent control of the sensitivity and response time of the artificial melanosome, while preventing leaching of melanin or its precursors.

Here, we apply a similar bio-inspired approach to design a tamper-indicating device that indicates the failure of a seal via acute sensitivity to oxygen, using only non-toxic materials. We draw inspiration from the chemical processes that take place in our skin, which provide a highly visible account of its exposure history through the environmentally triggered production of melanin. Due to its interesting photo-protective, optical, electronic, and biochemical properties, a large number of synthetic routes for producing melanins have been developed. While the synthesis of melanin on our bodies occurs through more complex biochemical pathways, melanin can be synthesized in the lab from amino-acid derivatives through a variety of much simpler reactions. For example, melanin synthesis occurs spontaneously when basic solutions of L-DOPA are exposed to oxygen.

We created artificial melanosomes, consisting of deoxygenated pockets of basic L-DOPA solution contained within oxygen permeable polymer films. These films allow the precursors to be exposed to oxygen, but prevent their leaching into the outside environment. The artificial melanosomes remained colorless until exposed to oxygen, at which point the triggered melanin synthesis caused them to turn brown. By tuning the thickness of the oxygen-permeable polymer layer, we could adjust the time delay between the exposure event and the onset of color change. This tuning potentially allows the record of tampering to remain inconspicuous until long after the tamperer has left. The device is low cost, and requires no specialized equipment or electrical input, in contrast to many other types of oxygen sensors (e.g., Clark type electrode sensors, paramagnetic gas sensors, optical sensors, etc.). Using no toxic materials and showing high resistance to leaching, artificial melanosomes could find use as tamper-indicating materials in consumer applications. Furthermore, the deoxygenated precursor material is stable and non-reactive under an inert atmosphere and can therefore endure the functional lifetime of a packaged product.

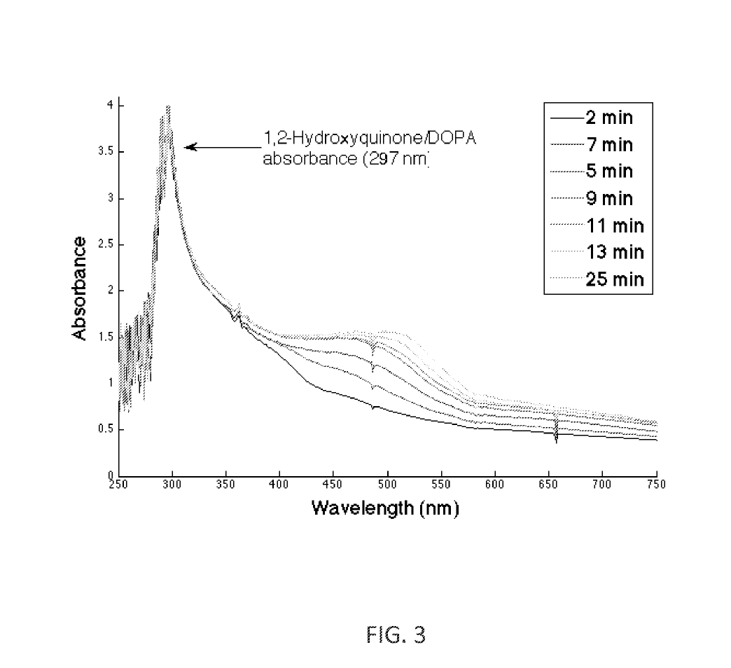

The artificial melanosome consists of a gas-permeable film that contains one or more pockets of the transparent deoxygenated precursors to synthetic melanin. When the film is exposed to oxygen, diffusion of the gas through a permeable rubber layer catalyzes the synthesis of the melanin pigment via spontaneous polymerization of L-DOPA under weakly alkaline (pH 8-9), aqueous conditions (FIG. 2). Formation of melanin corresponds to the appearance of a dark brown color. The oxidative polymerization of L-DOPA has a characteristic absorption profile, which permits quantitative determination of the oxygen diffusion rate through the rubber casing and the response time of melanosomes of different thicknesses. Hydroxyquinone oxidation causes an increase in absorbance intensity in the UV range (350-750 nm). A characteristic absorbance peak at 340 nm is also intensified. The hydroxyquinone moiety on L-DOPA absorbs strongly at 297 nm; this peak is retained in the DOPA-melanin spectrum since there are reduced hydroxyquinones dispersed within the polymer structure. Oxidation of L-DOPA to generate the quinone produces an increase in absorbance intensity in the UV range (400-650 nm) and a peak around 340 nm (FIG. 3).

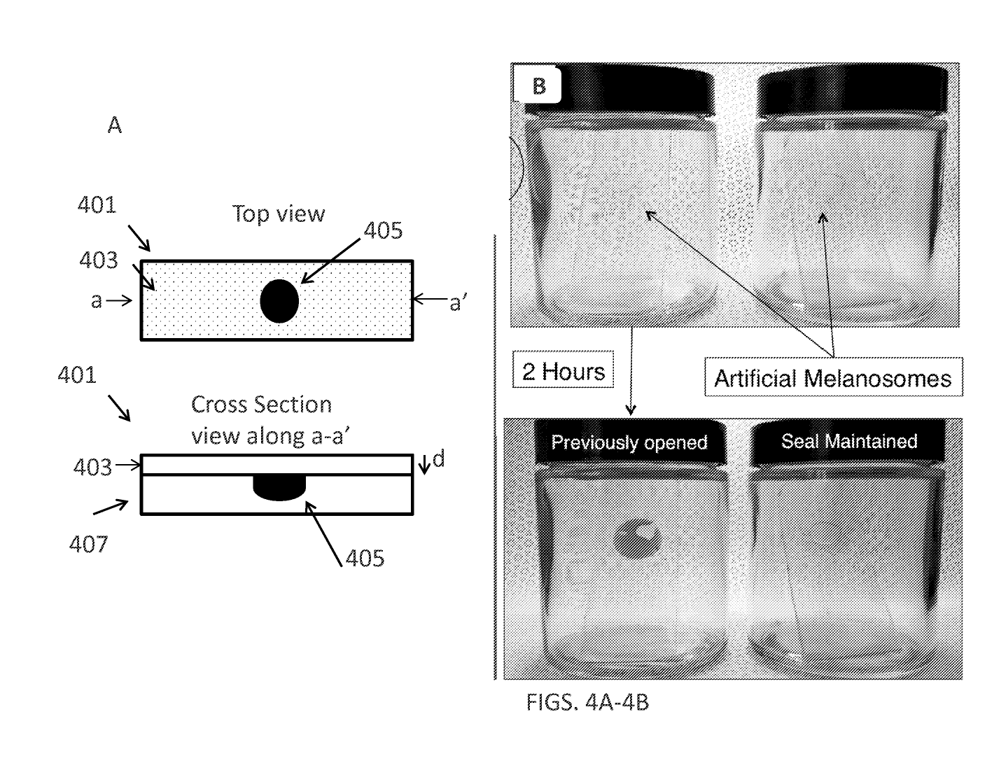

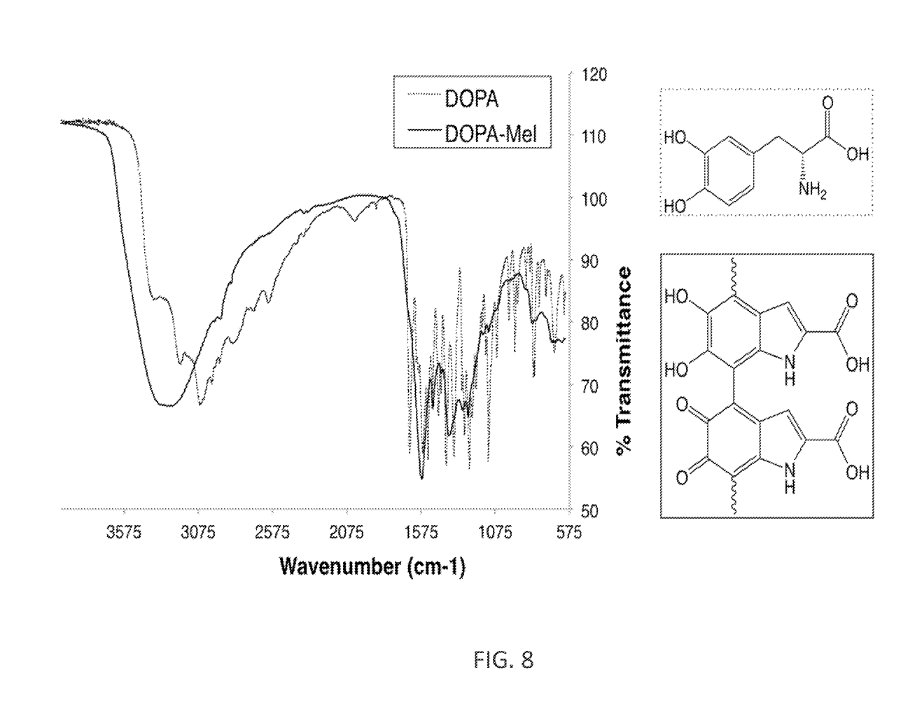

A demonstration of how artificial melanosomes function as tamper-indicating materials is shown in FIGS. 4A-4B. Artificial melanosomes 401, consisting of glass slides 407 containing 250 μL depressions with a circular (d˜1 cm) exposed surface filled with 0.3 M L-DOPA solution 405, capped with 2 mm thick layers of a selectively permeable silicone rubber (PDMS) 403 (FIG. 4A), were placed in two sealed glass jars (250 mL total volume) under nitrogen (FIG. 4B). Note that the L-DOPA 405 was placed underneath the PDMS layer 403 at the depth of d=2 mm. After both jars were removed from the inert atmosphere, one jar was opened for 5 seconds and resealed. After a delay of 5 hours the artificial melanosome in the jar that was previously opened changed from a pale, nearly colorless solution to a completely opaque, black pigment, while no color change occurred in the unopened jar (FIG. 4B). The spectral verification of this oxygen-triggered synthesis of DOPA-melanin can be found in FIG. 8, where Fourier transform infrared spectral comparison of L-DOPA (dotted line) and DOPA-melanin (solid line). The most notable features are the bands from the —NH₂ stretch shifted upfield from the phenolic —OH band; these are seen in the L-DOPA spectra but are not observed for the DOPA-melanin polymer.

The absolute sensitivity of the artificial melanosome to oxygen depends on the amount of L-DOPA it contains and is therefore tied to the melanosome size. For a fixed L-DOPA concentration (e.g., 300 mM), its volume is inversely proportional to its oxygen sensitivity. Using the 2:1 stoichiometric ratio of oxygen and L-DOPA in the polymerization reaction, we can determine the limiting size relationship between the artificial melanosome and the detectable volume of oxygenated air (e.g., contained within a opened and resealed container). Comparing the molarity of L-DOPA in the solution (300 mM) with that of oxygen in air (9 mM), we can determine that the artificial melanosomes may be at least 67 times smaller than the volume of oxygen in the resealed container. After full conversion from L-DOPA to melanin, the solution has an absorbance of 3.48 at 297 nm, therefore melanosomes as thin as 1 mm will have visible color change (transmittance less than 50%). Taking 1 mm2 as the limit for an easily visible area, a visible color change can be produced from as little as 3 μmol of L-DOPA, requiring 6 μmol of oxygen or 0.7 mL of air to detect.

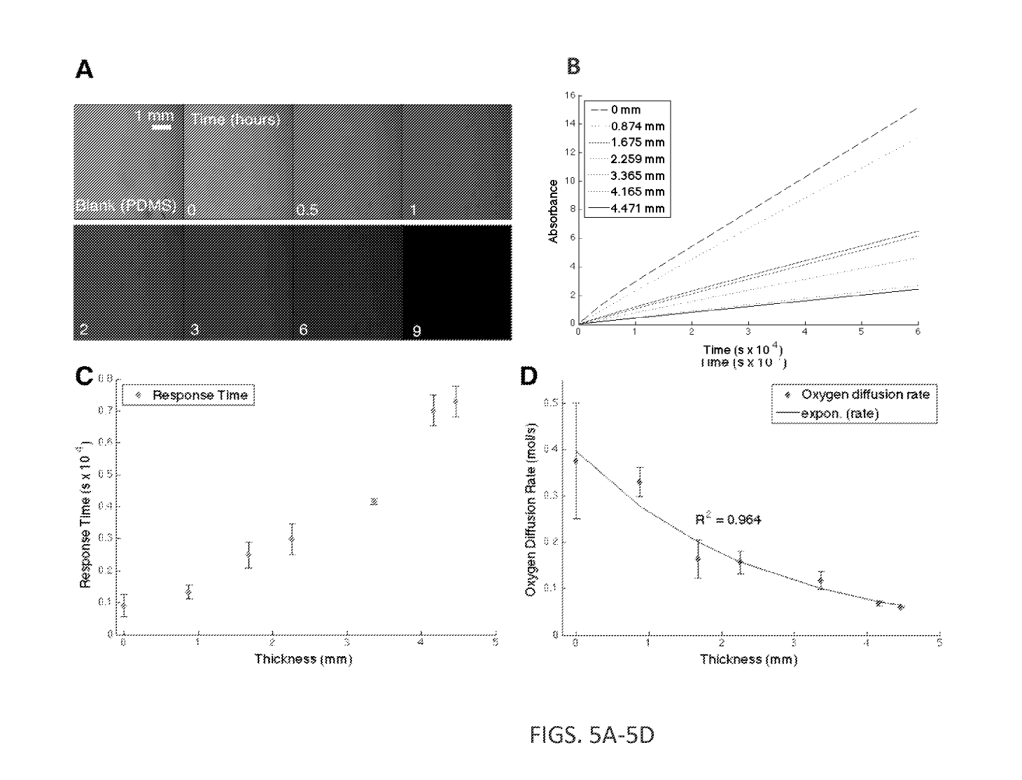

The time of response of artificial melanosomes to oxygen exposure can be tuned by adjusting the thickness of the encasing PDMS layer, which controls its permeability and thus the rate that it consumes oxygen from the environment. We cast uncured rubber into 3D printed moulds to make artificial melanosomes with controlled dimensions and permeability. The pockets were subsequently injected with the deoxygenated precursor solution. FIG. 5A shows the time-evolution of the color change. FIG. 5B shows the time response of the absorbance at 550 nm as a function of the membrane thickness. FIG. 5C shows the response time (time to 50% reduction in transmission) as a function of the membrane thickness. This time-sensitivity is tuned over a broad spectrum ranging from a few seconds (as the thickness approaches 0) to several hours for thicknesses of ˜2-5 mm. The linearity of the absorbance curves (FIG. 5B) and their slopes' dependence on membrane thickness suggest that reaction speed is determined by the rate of oxygen diffusion through the membrane, a rate that is constant for a given thickness. FIG. 5D shows how this diffusion rate varies with membrane thickness.

Separately adjusting the size of the melanosome reagent pocket and the gas-permeable membrane thickness allows determination of the response time and sensitivity to be decoupled. The ability to engineer long delay times for highly sensitive responses provides an added level of covertness for artificial melanosomes used as tamper-indicating materials. Delaying response until long after the bottle has been opened, tampered with and re-sealed would keep the response hidden from the perpetrator. However, delayed response would lead to poorer sensitivity if the container were de-oxygenated after tampering and re-sealing.

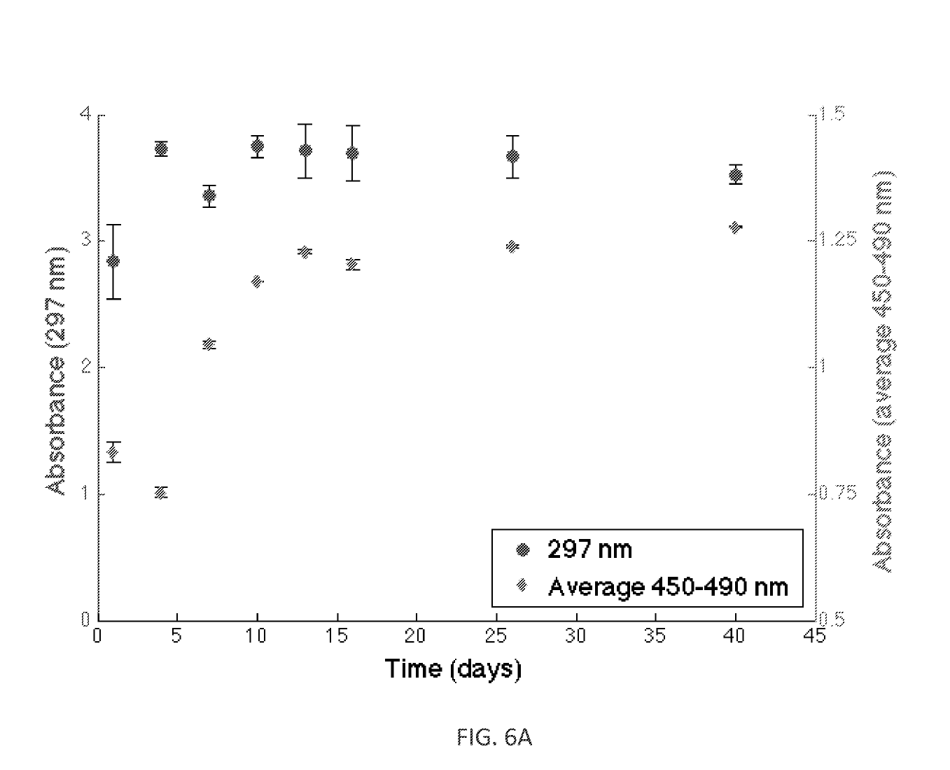

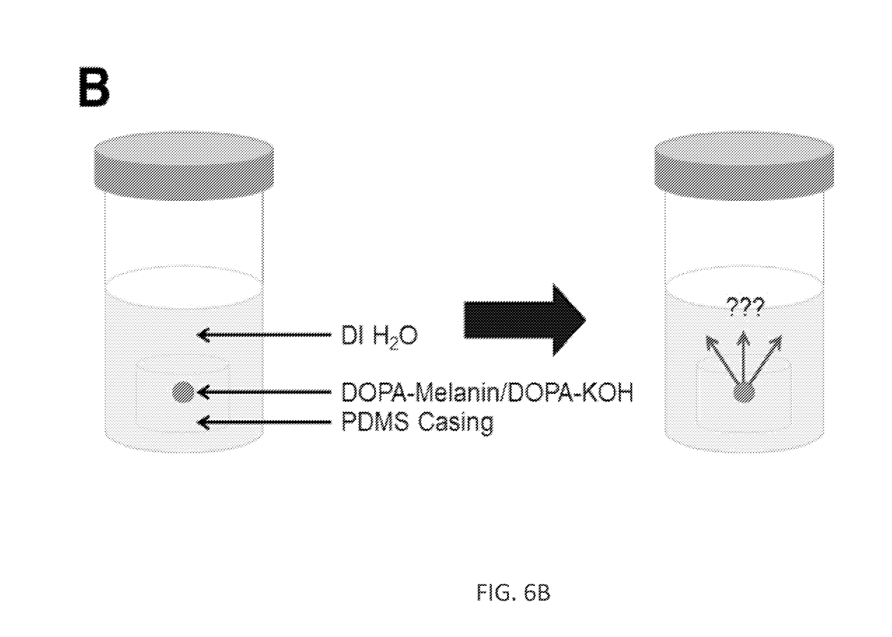

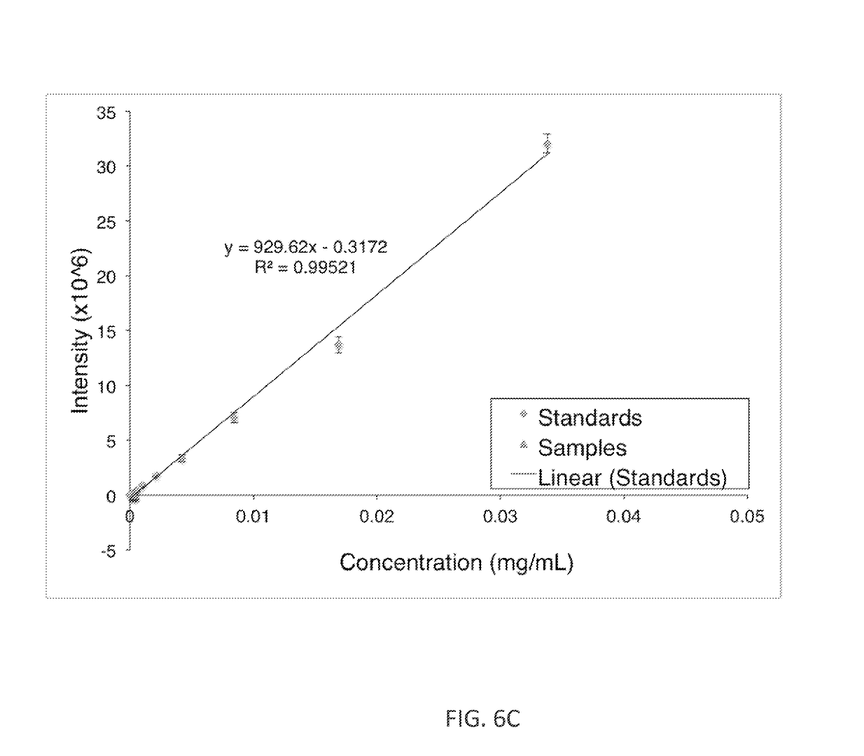

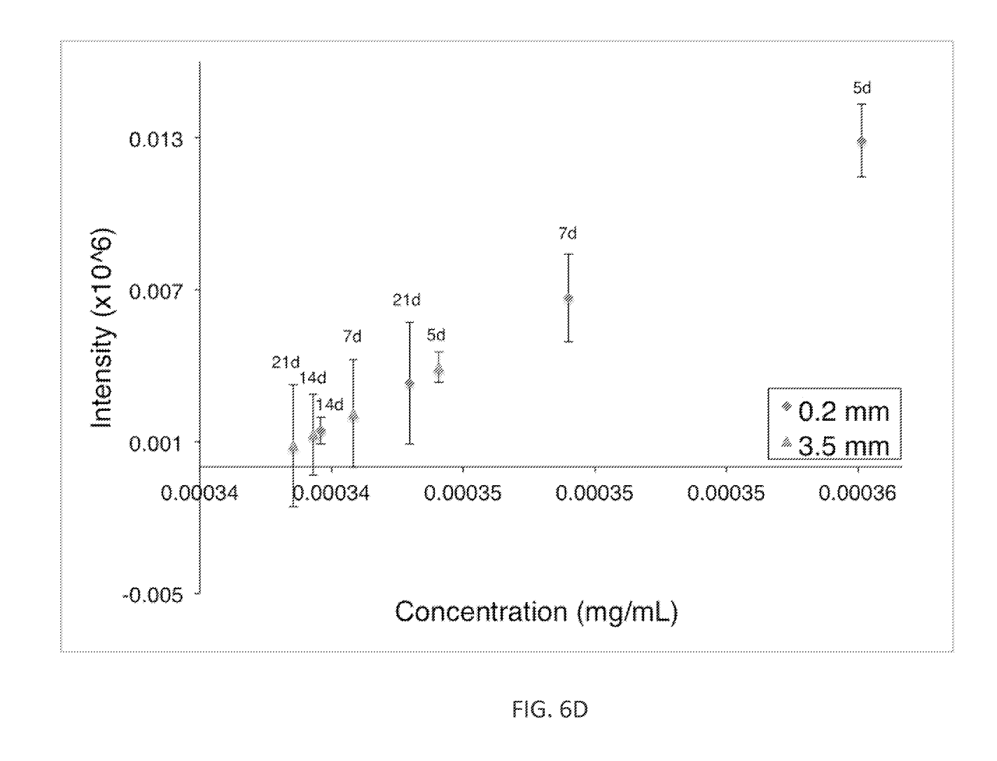

The use of artificial melanosomes for oxygen exposure detection also necessitates confirmation that the melanin precursors remain stable for long time in an inert atmosphere. All stock solutions are repeatedly degassed under high vacuum and back-filled with dry nitrogen before melanosome preparation in the glove box. Any residual dissolved oxygen is rapidly consumed once the precursor solution have been fully prepared, which renders the mixture a pale, translucent, yellow in lieu of the preferred clear solution (see FIG. 4B). After this slight initial change however, we found that this pale yellow is conserved as long as the solution remains under nitrogen. FIG. 6A shows the long-term stability of artificial melanosomes stored in sealed containers for up to 40 days. Hydroquinone absorbance intensity at 297 nm shows an initial increase between 1 and 4 days but remains stagnant over time and is far below the upper limit of absorption at full DOPA-melanin conversion as given by the open PDMS pocket shown in FIG. 1. Quinone absorbance in the UV range (450-490 nm) also increases initially but plateaus after 13 days. There is likely a finite and nearly negligible amount of molecular oxygen that drives the slow oxidation of L-DOPA and is consumed after about 2 weeks, after which the reaction terminates. Thus, there is insufficient evidence to suggest that L-DOPA is undergoing extensive polymerization without oxygen exposure. No visible color changes were observed in the artificial melanosomes after 40 days.

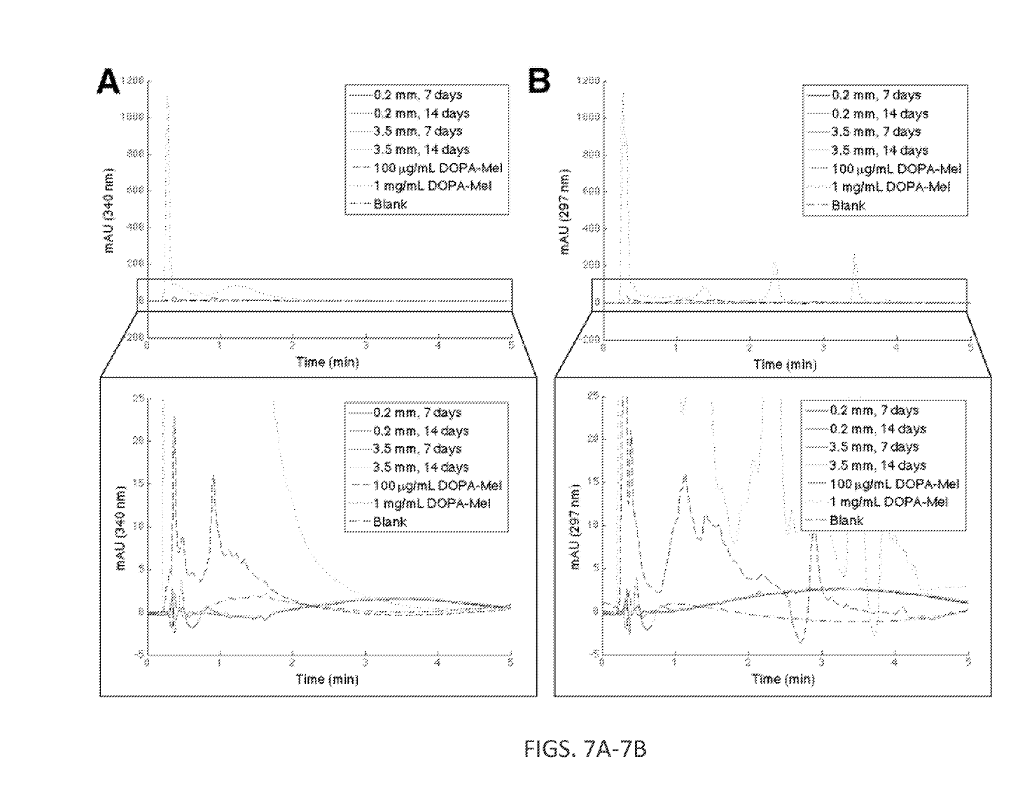

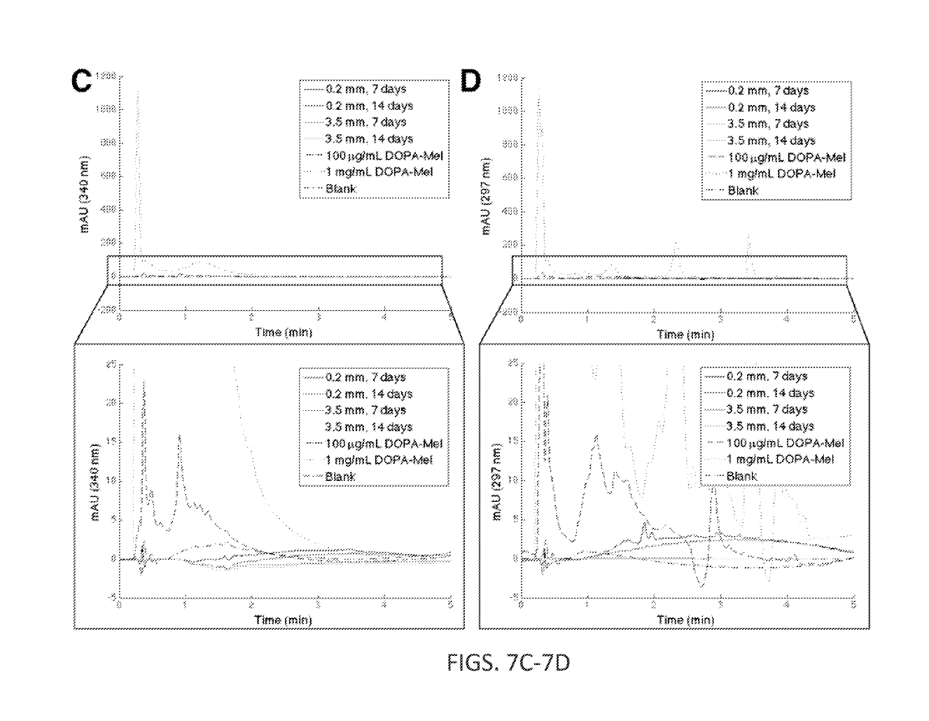

Safe integration of artificial melanosomes into consumer products also requires confirmation that the melanin precursors do not leach trough the silicone membrane and into the outside environment. Although the materials that constitute the device are not hazardous (L-DOPA is a nontoxic, FDA approved derivative of the amino acid tyrosine and silicone polymers are used prolifically for medical devices and consumer goods), we ensured that the oxygen sensitive solution was not able to leach out of the rubber casing. FIG. 6B describes the leaching test setup to determine potential leaching of DOPA-melanin into surrounding media. The pockets contain either DOPA-melanin or deoxygenated DOPA-KOH. The DI water was tested for trace amounts of DOPA-melanin and L-DOPA using fluorescence spectroscopy and HPLC with UV detection. Sealed artificial melanosomes containing DOPA-KOH (deoxygenated) and DOPA-melanin solutions (after oxygen exposure) were fabricated by curing the silicone polymer around a suspended droplet of the oxygen-responsive solution, so as to avoid leaving behind injection holes through which the liquid might diffuse. Specifically, artificial melanosomes with surface thicknesses of 3.5 mm and 0.2 mm were submerged in DI water for 3 weeks (under an inert atmosphere when testing leaching of de-oxygenated precursors). The surrounding media were extracted and analyzed for traces of DOPA-melanin and L-DOPA using HPLC. Fluorescence intensity, which was experimentally determined to be maximal when the melanin polymer is excited at 470 nm, was far below the limit of detection for the surrounding media of all samples after 21 days of incubation (FIGS. 6C and 6D). Samples were excited at 470 nm and detected at 550 nm, n=3. We confirmed this result and tested deoxygenated DOPA-KOH capsules for leaching using HPLC with UV detection at 297 nm (reduced hydroxyquinone) and 340 nm (oxidized quinones) after 2 weeks of incubation. The surrounding media from neither samples of deoxygenated DOPA-KOH nor samples of DOPA-melanin gave absorbance peaks at these wavelengths (FIGS. 7A-D). Specifically, HPLC analysis of DOPA-KOH (FIGS. 7A and 7B showing absorption at 340 nm and 297 nm, respectively) and DOPA-melanin (FIGS. 7C and 7D showing absorption at 340 nm and 297 nm, respectively) leaching from within artificial melanosomes submerged in DI water with thicknesses of 3.5 mm and 0.2 mm. Water samples were detected with a UV/VIS spectrometer at 340 nm and 297 nm. No significant peaks were observed for any of the samples when compared to DOPA-melanin standard solutions, indicating that the PDMS casing prevents leaching of its contents into the surrounding media. Therefore we concluded that leaching through the encapsulating polymer was negligible.

Thus, inspired by nature's own stimuli responsive systems, we created a surface coating that reports oxygen exposure through irreversible color change. The color change derives from the oxygen dependent synthesis of dark melanin pigment from a colorless, catecholamine precursor (L-DOPA) encapsulated in an oxygen-permeable polymer film. The thickness of the encapsulating layer regulates the rate of oxygen diffusion, and enables the response time to be tuned separately from the sensitivity, the latter being limited by the melanosome size. We envision that artificial melanosomes could fund use as low-cost indicators for validating the integrity of sealed packaging and detecting tampering. Non-toxic and remaining stable and non-reactive for at least 40 days, artificial melanosomes have the potential to endure the functional lifetime of many packaged goods that might benefit from this type of integrity monitoring, including food, beverages, pharmaceuticals, or chemical products.

### Structural Characterization

IR spectra (FIG. 8) were obtained using a Bruker Vertex70 Fourier-transform infrared spectrometer (FTIR) with the ZnSe crystal ATR attachment. Specifically, Fourier transforms infrared spectral comparison of L-DOPA (dotted line) and DOPA-melanin (solid line). The most notable features are the bands from the —NH₂ stretch shifted upfield from the phenolic —OH band; these are seen in the L-DOPA spectra but are not observed for the DOPA-melanin polymer.

### Synthesis of DOPA-Melanin Precursor Solution

Potassium hydroxide (KOH) stock solutions (1.53 M) were prepared by dissolving KOH pellets in deionized water and stirring at RT for 10 minutes. Oxygen-containing stock solutions were stored in sealed containers at room temperature. A 50 mL aliquot of stock solution was added to a round bottom flask, evacuated under high vacuum for 2 hours to remove dissolved oxygen, and backfilled with dry N₂ gas for 1 hour. This was repeated 4 times; the resulting deoxygenated flask was further sealed with parafilm and electrical tape before introduction into the glove box. L-DOPA (0.310 g, 1.57 mmol, 1 equiv) was deposited into a 20 mL vial and sealed with a septum and electrical tape inside of the glove box. Stock KOH solution (5 mL, 3.14 mmol, 2 equiv) was injected into the sealed vial to dissolve the L-DOPA; the precursor solution was kept in the glove box anti-chamber under nitrogen until ready to use.

### Preparation of PDMS Encapsulated DOPA-Melanin (“Artificial Melanosomes”)

Polydimethylsiloxane (PDMS) polymer precursor and curing agent were mixed in a 10:1 ratio and centrifuged (2000 rpm, 30 s). The polymer was poured into the 3D printed templates and cured for 30 minutes at RT under high vacuum (25 Hg) and then for 1 hour at 65° C. under ambient conditions. The top and bottom halves of the template were annealed inside of the glove box by painting a thin layer of uncured PDMS between the two halves and curing the sample on a 65° C. hot plate for 1.5 hours. The DOPA-KOH precursor solution (150 μL) was injected through the bottom of each well before testing. For optical transmission thickness tunability experiments, sample thicknesses were measured beforehand and the specific pocket to be tested was blanked on a modified optical microscope (Leica) and returned the glove box. The sample was placed in the glove box anti-chamber and evacuated under high pressure for 20 minutes and refilled (3×)—this conditioning step ensures that the PDMS pockets are equilibrated and remaining oxygen is removed before each experiment. The DOPA-KOH filled pockets were scanned for optical transmission under ambient conditions every 60 s for 12 hours. An arbitrary range of wavelengths (550-552 nm) were summed, normalized, fitted to the exponential function y=e^{-(t-t}^{₀}⁾/T_{c}, and then converted to absorbance units.

### Characterization of DOPA-KOH Stability

Stock deoxygenated KOH solution (10 mL, 6.28 mmol, 2 equiv) was injected into a vial containing L-DOPA (0.620 g, 3.14 mmol, 1 equiv) inside of the glove box. The vial was sealed and kept in the glove box for the duration of the experiment (40 days). To determine the degree of L-DOPA oxidation and chemical stability while under nitrogen, 700 μL aliquots of the precursor solution were removed from the glove box in sealed cuvettes and scanned for absorbance on an Agilent 8453 UV-Vis spectrometer at 297 nm and 340 nm. Wavelengths of interest were determined by monitoring the absorbance behaviour of L-DOPA throughout hydroxyquinone oxidation (FIG. 2).

### Preparation of DOPA-Melanin Pockets (No Injection Holes) for Chemical Leaching Experiments

DOPA-melanin and DOPA-KOH solutions were fashioned from the stock solution of 1.53 M KOH (2 equiv.) and L-DOPA (1 equiv.). DOPA-KOH solutions were fabricated in the glove box as previously described. DOPA-melanin and DOPA-KOH solutions (20 μL) were injected into partially cured PDMS (1:10 hardener:base, 30 min at 70° C.) to give the suspended, spherical melanin bubbles. The length of partial curing time was adjusted to obtain artificial melanosomes of different thicknesses. The samples were further cured for 30 min at 70° C. after injection. Soaking in 100% ethanol for 30 minutes to remove external contaminants equilibrated the PDMS pockets prior to evaluating leaching. The samples were submerged in DI water (25 mL) and left in sealed vials—the samples containing DOPA-melanin were incubated under ambient conditions and the samples with DOPA-KOH were incubated in the glove box. 1 mL of water was removed from the vials after 7 and 14 days and then tested for absorbance at 297 nm and 340 nm after application to an HPLC column.

### Standard Florescence Analysis of Leaching

Serial dilutions of pre-made DOPA-melanin solution (8.65 mg/mL) and samples of the surrounding media (DI water) in which the artificial melanosomes were submerged were deposited into 96 well plates (100 μL, n=3). KOH (0.356 M) and saturated DOPA-melanin solution were used as the negative and positive controls, respectively. The samples were excited at 470 nm and emission was detected at 550 nm on a SpectraMax i3-UV/VIS plate reader. A plot of concentration (mg/mL) versus fluorescence intensity gives the standard curve to which samples potentially containing leached DOPA-melanin or DOPA-KOH can be compared.

### HPLC Analysis of Leaching

The surrounding media samples were fed through an Agilent 1290/6140 Ultra High Performance Liquid Chromatographer, which consists of a 1290 Infinity LC binary pump and an Agilent 1290 Diode Array Detector. 10 μL of each sample were flowed through a mobile phase of 1% formic acid in acetonitrile at 0.5 μL/min for 5 minutes. Absorbance at 297 nm and 340 nm was measured to assess sample purity.

While for purposes of illustration a preferred embodiments of this invention has been shown and described, other forms thereof will become apparent to those skilled in the art upon reference to this disclosure and, therefore, it should be understood that any such departures from the specific embodiment shown and described are intended to fall within the spirit and scope of this invention.

What is claimed:

1. A tamper-indicating device comprising:
a gas-permeable casing; and
a first gas-sensitive compound encapsulated within the gas-permeable casing, wherein the first gas-sensitive compound is selected to provide a visual response upon exposure to a gas.

2. The tamper-indicating device of claim 1, wherein the visual indication is color change.

3. The tamper-indicating device of claim 1, wherein the gas is selected from the group consisting of oxygen, a nerve gas, volatile explosive, CO, CO₂, water vapor, HCl, H₂S, SO₂, NO₂, NH₃, O₃, NO and a combination thereof.

4. The tamper-indicating device of claim 1, wherein the intensity of the visual response is an indicator of the extent of gas exposure.

5. The tamper-indicating device of claim 1, wherein the casing comprises one or more openings or pores to allow the gas to permeate into the casing.

6. The tamper-indicating device of claim 1, wherein at least a portion of the casing is transparent to allow viewing of the visual response.

7. The tamper-indicating device of claim 1, wherein the first gas-sensitive compound is colorless and the visual response comprises a color change to a yellow, brown, or black color.

8. The tamper-indicating device of claim 1, wherein the casing is hydrophobic.

9. The tamper-indicting device of claim 8, wherein the casing is water-impermeable.

10. The tamper-indicating device of claim 8, wherein the casing is made of rubber.

11. The tamper-indicating device of claim 1, wherein the casing is hydrophilic.

12. The tamper-indicating device of claim 11, wherein the casing is oil-impermeable.

13. The tamper-indicating device of claim 12, wherein the casing is made of silicone.

14. The tamper-indicating device of claim 1, wherein the first gas-sensitive compound is encapsulated at a depth about 0.1-10 mm below the surface of the casing.

15. The tamper-indicating device of claim 1, wherein the gas is oxygen and the first gas-sensitive compound is a first oxygen-sensitive compound.

16. The tamper-indicating device of claim 15, wherein the oxygen-sensitive compound is a synthetic precursor of melanin.

17. The tamper-indicating device of claim 16, wherein the synthetic precursor of melanin forms melanin upon oxygen exposure.

18. The tamper-indicating device of claim 15, wherein the first oxygen-sensitive compound is an artificial melanosome.

19. The tamper-indicating device of claim 15, wherein the first oxygen-sensitive compound has the structure of formula (I), a salt, or a hydrate thereof, 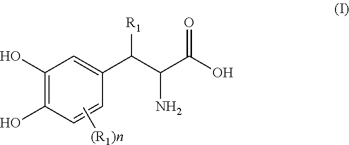
wherein n is 0, 1, 2, or 3; each occurrence of R₁ is independently selected from the group consisting of H, halogen, alkyl, alkenyl, cycloalkyl, alkylcycloalkyl, OH, SH, ORₐ, O(C═O)Rₐ, (C═O)ORₐ, (C═O)Rₐ, NH₂, NO₂, NRₐR_{b}, NRₐ(C═O)R_{b}, (C═O)NRₐR_{b}, NRₐ(C═O)OR_{b}, and O(C═O)NRₐR_{b}, wherein each occurrence of Rₐ and R_{b} is independently selected from the group consisting of H, halogen, alkyl, and cycloalkyl, or alternatively Rₐ and R_{b}, when connected to N, taken together with the nitrogen atom to which they are connected form a heterocycle comprising 1-4 heteroatoms, which may be optionally substituted by from one to four groups which may be the same or different (C₁-C₄)alkyl.

20. The tamper-indicating device of claim 19, wherein R₁ is H.

21. The tamper-indicating device of claim 1, wherein the first gas-sensitive compound is selected to provide the visual response after a predetermined time period after its exposure to the gas.

22. The tamper-indicating device of claim 21, wherein the predetermined time period is from about 1 min to about 5 h.

23. The tamper-indicating device of claim 1, further comprising one or more gas-sensitive compound encapsulated within the gas-permeable casing and each selected to provide visual response upon exposure to a gas.

24. The tamper-indicating device of claim 23, wherein the one or more gas-sensitive compound and the first gas-sensitive compound are encapsulated at the same or different depth below the surface of the casing.

25. The tamper-indicating device of claim 23, wherein the one or more gas-sensitive compound and the first gas-sensitive compound are selected to provide visual responses upon exposure to the same or different gas.

26. A method of detecting tampering of a product contained in a package substantially free of a gas and containing the tamper-indicating device of claim 1, comprising examining the device for the visual response to determine if the product has been exposed to the gas.

27. The method of claim 26, wherein the gas is oxygen and the first gas-sensitive compound is a first oxygen sensitive compound.

28. The method of claim 27, wherein the atmosphere inside the package contains less than 10%, 5%, or 1% oxygen.

29. The method of claim 27, wherein upon exposure to oxygen, the first oxygen sensitive compound forms an indicator compound with a color different from the first oxygen-sensitive compound and an appearance of the color of the indicator compound upon subsequent examination of the tamper-indicating device indicates prior tampering of the package.

30. The method of claim 27, wherein the package is at least partially transparent to allow a user to examine the color of the first oxygen-sensitive compound or the visual response.
